(19) United States
(12) Patent Application Publication
(10) Pub. No.: US 2014/0006569 A1
(43) Pub. Date: Jan. 2, 2014

(54) METHODS AND APPARATUS FOR ASSOCIATING A DEVICE TO A NETWORK

(71) Applicants: Axel FERRAZZINI, Uccle (BE); Jason Lee CARTER, Davie, FL (US); Richard Enrique LOPEZ, Miami, FL (US); Thomas Owen PARRY, Cambridge (CA)

(72) Inventors: Axel FERRAZZINI, Uccle (BE); Jason Lee CARTER, Davie, FL (US); Richard Enrique LOPEZ, Miami, FL (US); Thomas Owen PARRY, Cambridge (CA)

(21) Appl. No.: 13/536,989

(22) Filed: Jun. 28, 2012

(51) Int. Cl. G06F 15/177

(52) U.S. Cl. 709/220

(57) ABSTRACT

Provisioning data is shared with a new device being added to a home environment network. An existing home environment device may receive a request from the new device and transmit provisioning information for user services to the new device. Coordination between the new device and plurality of home environment devices provide for notifications of the provisioning request at several home environment devices. The notifications are removed from other home environment devices when a user responds to one of the notifications at a particular home environment device.

### FIELD OF THE DISCLOSURE

This disclosure relates generally to network communication, and, more particularly, to methods and apparatus for connecting a device to a network.

### BACKGROUND

As the cost of networking technology has decreased, the extent of networks in homes, also known as the home environment, has expanded. The number and types of devices connected to home networks have grown to include televisions, refrigerators, telephones, alarm systems, climate control systems, etc. in addition to traditional computing devices such as desktop computers, laptop computers, and smart phones. Furthermore, the types of communication technologies have grown to include short range connectivity such as near field communication (NFC), quick response (QR) codes, Wi-Fi direct, radio frequency identification (RFID), Bluetooth, etc. in addition to traditional communication technologies such as Ethernet, wireless local area network, etc.

### BRIEF DESCRIPTION OF THE DRAWINGS

FIG. 1 is a block diagram of an example system that includes a home environment.

FIG. 2 is a message diagram illustrating communication between devices in for provisioning a device in the home environment of FIG. 1.

FIGS. 3 and 4 are flowcharts representative of example machine readable instructions for implementing one or more devices in the home environment of FIG. 1.

FIG. 5 is a table of provisioning data that includes service account information.

FIG. 6 is a block diagram of an example computer capable of executing the instructions of FIGS. 3 and 4 to implement the devices of the home environment of FIG. 1.

### DETAILED DESCRIPTION

People without formal computing network training may still operate and manage home environment networks. Accordingly, it is desirable to make the management of such networks easy and intuitive. Methods and apparatus disclosed herein facilitate associating a device to a home environment network. The device may be a new device that has not previously been added to the home environment. Alternatively the device may not have been used in the home environment for a long time, or may not have previously received some or all networking parameters or other provisioning data, etc. The methods and apparatus disclosed herein facilitate the transfer of information about user services (e.g., usernames and passwords for services) to which one or more users of the home environment subscribe) to the device. In an example disclosed herein, a new device is brought into proximity of the home environment and/or brought into proximity with another device associated with the home environment. The new device announces its presence to the home environment and/or the other device associated with the home environment. One or more devices that are already associated with the home environment may display a notification regarding the new device and request approval for configuring the new device. Upon receiving a response to the notification at one of the devices (e.g., an approval or a disapproval), the notification is removed from the remaining devices. The request to configure the new device is approved at one of the home environment devices, the home environment device transfers provisioning data to the new device. The provisioning data may include parameters used for accessing a network of the home environment, authentication information for the home environment, information about other devices in the home environment, etc. In addition, the provisioning data includes information about user services (or a link to such information). The information about user services enables the new device to access the user services without a user re-entering the information into the new device. The information about the user services may be selectively provided to the new device based on capabilities of the new devices reported in the announcement of the devices presence in the home environment.

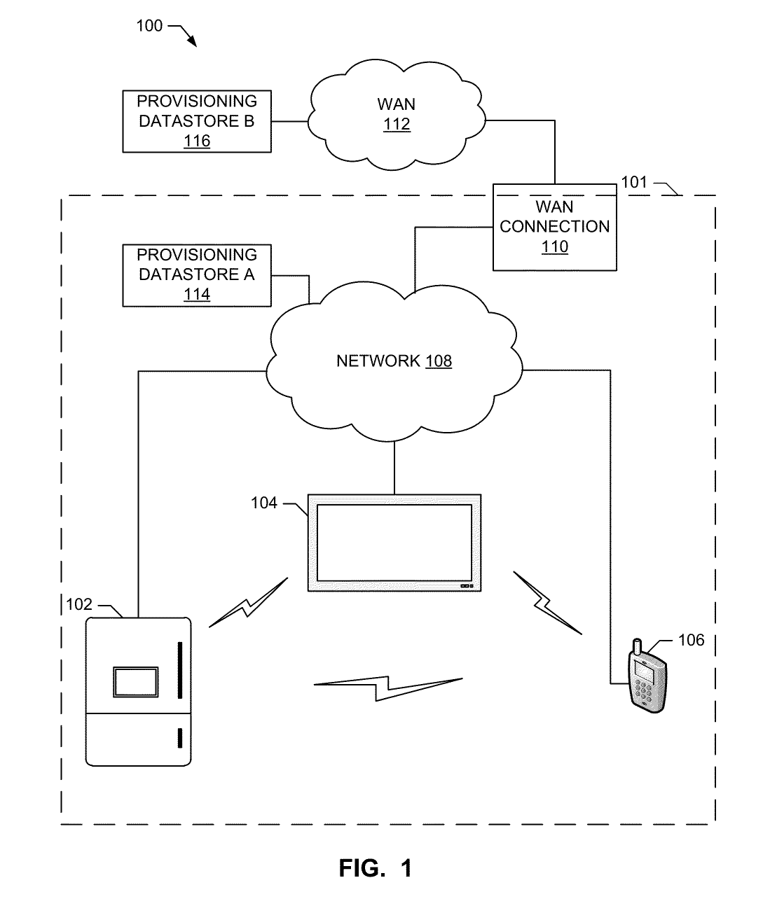

FIG. 1 is a block diagram of an example system 100 that includes a home environment 101. The example home environment 101 includes a refrigerator 102, a television 104, a mobile device 106, a network 108, a wide area network (WAN) connection 110, and a provisioning datastore A 114. The WAN connection 110 connects the home environment to a WAN 112 (e.g., the Internet). A provisioning datastore B 116 may also be connected to the WAN 112.

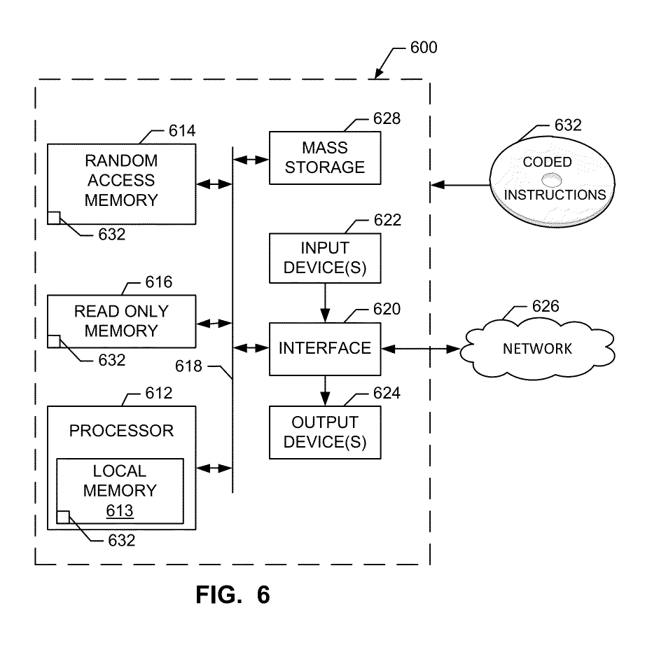

The refrigerator 102, the television 104, and the mobile device 106 associated with the home environment 101 are or include computing elements, such as the processor, a memory, or any other element described in conjunction with processor system 600 of FIG. 6. According to the illustrated example, the refrigerator 102, the television 104, and the mobile device 106 are communicatively coupled to the network 108. The refrigerator 102, the television 104, and the mobile device 106 may communicate with one another using network 108, device-to-device, peer-to-peer, short range connectivity, or any other type of communication such as, for example, NFC, Wi-Fi direct, Bluetooth, RFID, QR codes, etc. The network 108 and/or the device-to-device connection may utilize one or more systems such as digital living network alliance (DLNA), universal plug and play (UPnP), Apple AirPlay, zero configuration networking, etc.

The network 108 may be a wireless network, a wired network, or any other type of network and may comprise a network element such as a gateway, a router, switch, hub, etc. The network 108 may be a local area network (LAN) or any other type of network and may comprise one network or several networks. According to the illustrated example, the network 108 is communicatively coupled with the WAN connection 110. The WAN connection 110 communicatively couples the network 108 in the devices connected with the network 108 with the WAN 112. For example, the WAN 112 may be the Internet. Alternatively, the WAN 112 maybe any other type of WAN or any other type of network.

The example system 100 includes the provisioning datastore A 114 and the provisioning datastore B 116 communicatively coupled to the WAN 112. The provisioning datastore A 114 and the provisioning datastore B 116 store provisioning data that may be requested by a computing device in the home environment 101. For example, if the television 104 is a new device introduced to the home environment 101, the mobile device 106 may provision the television 104 by transmitting a universal resource locator (URL) that identifies one of the provisioning datastore A 114 or the provisioning datastore B 116 to the television 104. The provisioning datastore A 114 and/or the provisioning datastore B 116 may be a server, a database, a hard drive, or any other computing device that is capable of storing and transmitting provisioning data. It should be understood that the provisioning datastore A 114 may be included in a computing device that is part of the example home environment 101.

According to the illustrated example, new computing devices automatically notify other computing devices in the home environment 101 when the new computing devices are in the home environment 101. A new computing device may be considered to be in the home environment 101 when the new computing device is within a wireless communication range of the network 108 or any of the computing devices (e.g. the refrigerator 102, the television 104, and the mobile device 106) associated with the home environment 101. For example, if the television 104 were new to the home environment 101, when the television 104 were powered on, the television 104 may recognize that it is within communication range of the refrigerator 102 and the mobile device 106 based upon a short-range radio frequency signal, local area network private IP address range, NFC tapping, or the like. In this example, the television 104 transmits communication signal to the refrigerator 102 and the mobile device 106 indicating that the television 104 would like to join the home environment 101 and, optionally, indicating the capabilities and features of the television 104. The communication signal may be referred to as an advertisement (the new device is advertising its presence in the home environment). It should be understood that the advertisement may be a broadcast or unicast signal, and may be a message or other protocol signaling over a communications channel. In response to the communication signal, the refrigerator 102 and the mobile device 106 display a notification requesting user approval to provision the television 104. A user of the refrigerator 102 or the mobile device 106 may then authorize the respective one of the refrigerator 102 or the mobile device 106 to transmit provisioning data to the television 104 as described in greater detail herein.

While some of the examples described in the foregoing make reference to particular ones of the refrigerator 102 the television 104 and the mobile device 106, these references are made by example only. A home environment 101 may include any number and types of devices and any of the devices may be joined to the home environment 101 and/or may provision other devices in the home environment 101.

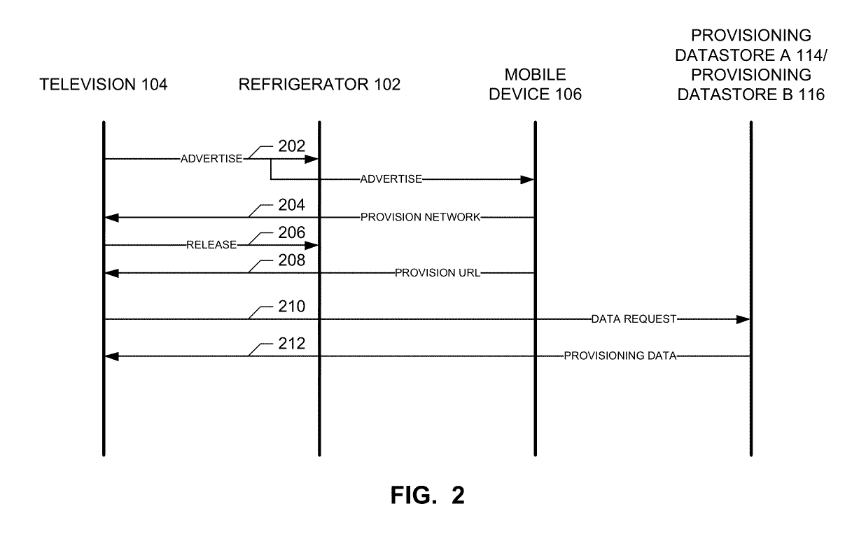

FIG. 2 is a message diagram illustrating example messages that may be transmitted to join the television 104 to the home environment 101. The example of FIG. 2 begins when the television 104 transmits an ADVERTISE message 202 to the refrigerator 102 and the mobile device 106. The ADVERTISE message 202 may include one or more of: a notification that the television 104 is within range of the home environment 101, a request for the television 104 to join the home environment 101, a list of capabilities of the television 104, a list of features of the television 104, a list of services with which the television 104 may communicate, etc. In response to the ADVERTISE message 202, the refrigerator 102 and the mobile device 106 display a notification on their respective displays requesting authorization to provision the television 104. According to the illustrated example, a user of the mobile device 106 has authorized the mobile device 106 to provision the television 104.

In response to the ADVERTISE message 202 and the authorization to provision the television 104, the mobile device 106 transmits the PROVISION NETWORK message 204 to the television 104. According to the illustrated example, the PROVISION NETWORK message 204 includes information and parameters to be used by the television 104 to connect to the network 108 and/or any other device of the home environment 101. For example, the PROVISION NETWORK message 204 may include a service set identifier (SSID) and an encryption key associated with the network 108.

According to the illustrated example, in response to the PROVISION NETWORK message 204, the television 104 may transmit a RELEASE message 206 to the refrigerator 102. The RELEASE message 206 notifies the refrigerator 102 that provisioning of the television 104 has been initiated by another device (e.g., the mobile device 106). Accordingly, the refrigerator 104 terminates the display of the notification associated with the ADVERTISE message 202 on the refrigerator 102. Thus, while the notification in response to the ADVERTISE message 202 may be displayed on multiple devices in the home environment 101, display of those notifications is terminated when one of the devices (e.g., the mobile device 106 in this example) begins provisioning of the device that transmitted the ADVERTISE message 202 (e.g., the television 104 in this example). While the RELEASE message 206 is transmitted from the television 104 to the refrigerator 102 (or broadcast to all devices in the home environment 101) in the illustrated example, the RELEASE message 206 may alternatively be sent to the refrigerator 102 or broadcast to the home environment 101 by the device that is initiating provisioning of the television 104 (e.g., the mobile device 106 in the example of FIG. 2). Additionally or alternatively, devices in the home environment that are displaying a provisioning notification in response to the ADVERTISE message 202 may monitor or poll the television 104 to determine if provisioning has been initiated and may terminate the display of the notification when provisioning has been initiated by another device.

The mobile device 106 may transmit a PROVISION URL 208 to the television 104. The PROVISION URL 208 indicates a location or device from which the television 104 may retrieve further provisioning data. The PROVISION URL 208 may be a hypertext transport (HTTP) address, a secure hypertext transport (HTTPS) address, Internet protocol (IP) address, a network file path, file transport protocol (FTP) address, or any other link, location, or address. The PROVISION URL 208 may be sent as a separate communication after transmitting the PROVISION NETWORK message 204, as shown in FIG. 2. Alternatively, the PROVISION URL 208 may be included in the PROVISION NETWORK message 204. The PROVISION NETWORK message 204 may include provisioning data in addition to or in lieu of the PROVISION URL 208.

In response to receiving the PROVISION URL message 208, the television 104 may transmit a DATA REQUEST message 210 to the one of the provisioning datastore A 114 or the provisioning datastore B 116 identified in the provision URL 208. In response to the DATA REQUEST message 210, the one of the provisioning datastore A 114 or the provisioning datastore B 116 transmits PROVISIONING DATA 212 to the television 104. The PROVISIONING DATA 212 may include information about the home environment, information about devices in the home environment, information about services to which one or more users of the home environment subscribe, etc.

Provisioning data provided by the mobile device 106 to the television 104 and/or provided by one or more of the provision datastore A 114 or the provision datastore B 116 may include, as non-limiting examples:
parameters used for accessing the network 108 or any other network of the home environment 101,
authentication information for the home environment 101,
information about other devices in the home environment 101,
information for accessing user services to which one or more users of the home environment 101 subscribe or access,
information for configuring settings of the television 104,
user-specific settings or identifiers associated with users in the home environment.

The provisioning information sent to the television 104 may be customized based on the features and capabilities of the television 104. For example, when the provisioning data includes information about other devices in the home environment 101, the mobile device 106 may send (or may customize the URL) information about other devices that are like the television 104 (e.g., other devices in the same device category as the television 104 such as other televisions) or other devices with which the television can communicate (e.g., a media host). For example, the ADVERTISE message 202 may indicate the device category of the television 104, the capabilities of the television 104, features of the television 104, the types of devices with which the television 104 can communicate, etc.

The television 104 stores the provisioning data and distributes the data to any applications that utilize the data. For example, if the provisioning data includes user account information for accessing media on the Internet, the television 104 may distribute the user account information to an application on the television 104 that accesses media on the Internet. Accordingly, the television 104 is provided information for accessing services without a user of the television 104 manually inputting the information on an interface of the television (e.g., on the television screen, on a webpage associated with the television, etc.).

While an example manner of implementing the home environment 101 of FIG. 1 has been illustrated in FIG. 1, one or more of the elements, processes and/or devices illustrated in FIG. 1 may be combined, divided, re-arranged, omitted, eliminated and/or implemented in any other way. Further, the example refrigerator 102, the example television 104, and the example mobile device 106, the example provision datastore A 114, the example provision datastore B 116, and/or, more generally, the example home environment 101 of FIG. 1 may be implemented by hardware, software, firmware and/or any combination of hardware, software and/or firmware. Thus, for example, any of the example refrigerator 102, the example television 104, and the example mobile device 106, the example provision datastore A 114, the example provision datastore B 116, and/or, more generally, the example home environment 101 of FIG. 1 could be implemented by one or more processor(s), circuit(s), programmable processor(s), application specific integrated circuit(s) (ASIC(s)), programmable logic device(s) (PLD(s)) and/or field programmable logic device(s) (FPLD(s)), etc. Any of the apparatus or systems of this disclosure may include software and/or firmware implementations, and may be expressly defined to include a tangible computer readable medium such as a memory, DVD, CD, BluRay, etc. storing the software and/or firmware. Further still, the example home environment 101 of FIG. 1 may include one or more elements, processes and/or devices in addition to, or instead of, those illustrated in FIG. 1, and/or may include more than one of any or all of the illustrated elements, processes and devices.

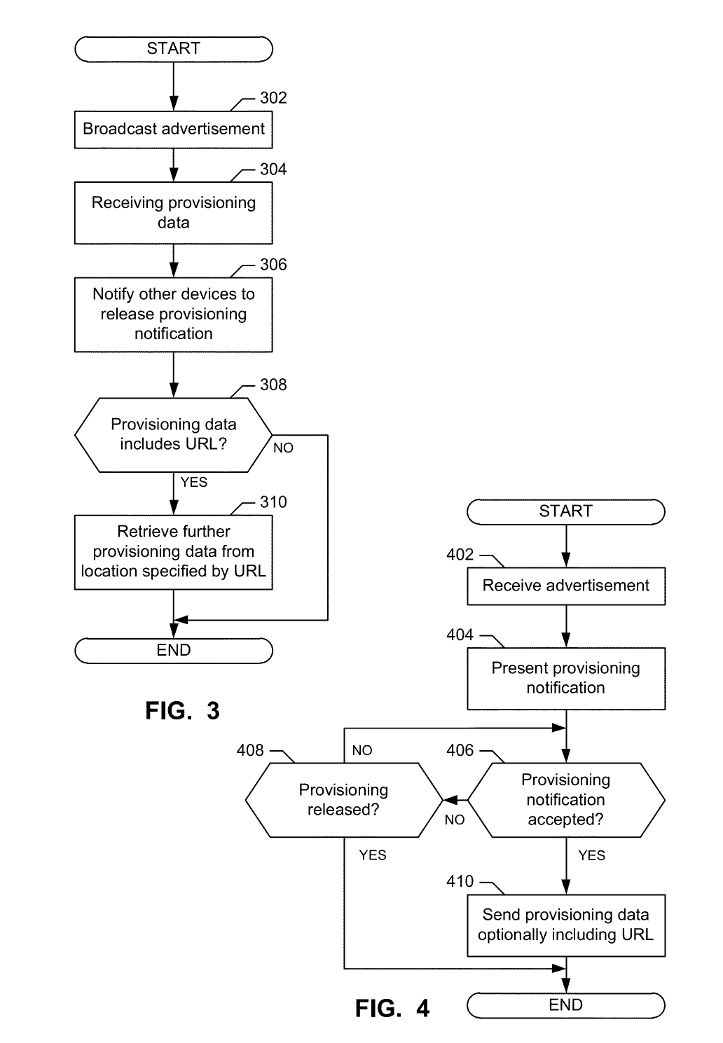

A flowcharts representative of example machine readable instructions for implementing one or more of the refrigerator 102, the television 104, the mobile device 106, or any other computer device in a home environment is shown in FIGS. 3-4. The machine readable instructions comprise programs for execution by a processor such as the processor 612 shown in the example computer 600 discussed below in connection with FIG. 6. The programs may be embodied in software stored on a tangible computer readable medium such as a CD-ROM, a floppy disk, a hard drive, a digital versatile disk (DVD), a BluRay disk, or a memory associated with the processor 612, but the entire program and/or parts thereof could alternatively be executed by a device other than the processor 612 and/or embodied in firmware or dedicated hardware. Further, although the example programs are described with reference to the flowcharts illustrated in FIGS. 3-4, many other methods of implementing the example the refrigerator 102, the television 104, the mobile device 106, or any other computer device may alternatively be used. For example, the order of execution of the blocks may be changed, and/or some of the blocks described may be changed, eliminated, or combined.

The example flowchart of FIG. 3 begins when a new device (e.g., the television 104) is to be added to the home environment 101 of FIG. 1. The new device broadcasts a communication signal (e.g. an advertisement message) to a plurality of home environment devices in the home environment 101 (block 302). As described in conjunction with FIG. 4, a selected one of the home environment devices (e.g., the mobile device 106), responds to the communication signal by transmitting provisioning data. The new device receives the provisioning data (block 304). In response to receiving provisioning data from the selected home environment device, the new device broadcasts a notification to release the provisioning notification on other home environment devices (block 306). Accordingly, other devices (e.g., the refrigerator 102) terminate display of a notification regarding provision the new device. Alternatively, if the selected home environment device directly notifies other home environment devices that the selected home environment device is provisioning the new device, then block 306 may be eliminated from the example flowchart.

According to the illustrated example, the new device determines if the provisioning data includes a URL (block 308). For example, the provisioning data may include a URL identifying a location from which the new device is to retrieve further provisioning data. In some implementations, a URL may be transmitted with other provisioning data (e.g., network provisioning data). In other implementations, the URL may be transmitted in a provisioning message that is separate from other provisioning data (e.g., network provisioning data) as shown in FIG. 2. When no URL is provided, the program of FIG. 3 is complete.

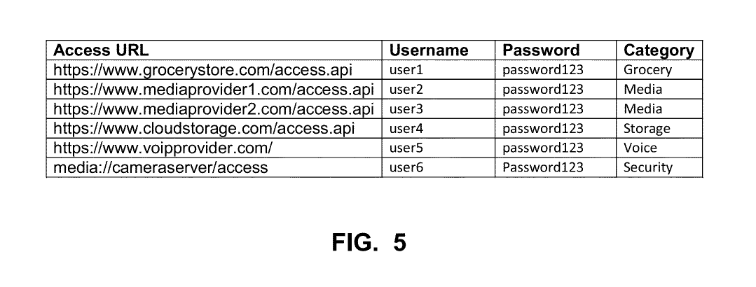

When a URL is included in provisioning data (block 308), the new device retrieves further provisioning data from the location specified by the URL. The further provisioning data may include information for accessing service accounts available to or subscribed to by one or more users of the home environment. Example further provisioning data is described in conjunction with FIG. 5. The URL may identify, and the further provisioning data may be retrieved from, one or more of the provisioning datastore A 114, the provisioning datastore B 116, or any other data source. The services may include services that provide media, data, information, security information, instant messaging, product ordering, groceries, etc. such as Netflix®, Hulu®, iTunes® Store, Amazon.com®, Peapod®, Amazon S3, Dropbox, Skype®, PANDORA®, etc. The information provided may include usernames, passwords, access details (e.g., URLs), API locations, API keys, etc.

While not shown in FIG. 3, the new device may process and store the provisioning data and further provisioning data. For example, if the provisioning data includes information for accessing the network 108 (e.g., in an implementation where the new device is communicatively coupled with the selected home environment device via a short range connectivity or other direct connectivity), the new device may store the information for accessing the network 108 and may configure a network interface to gain access to the network 108 prior to retrieving the further provisioning data in block 310 via the network 108.

FIG. 4 is a flowchart of an example program to provision a new device (e.g., the television). For example, the program of FIG. 4 may be executed at the selected home environment device. The example flowchart of FIG. 4 begins when a home environment device that is already associated with a home environment 101 (e.g., the mobile device 106) receives a communication signal (e.g. advertisement message) from a new device (e.g., the television 104) that the new device is within communication range of the home environment 101 and/or would like to join the home environment 101 (block 402). The home environment device presents a provisioning notification on a user interface (e.g. display) of the home environment device. For example, the provisioning notification may request authorization to provision the new device, may request information for provisioning the new device (e.g., security information, naming information, capability information, etc.), and so forth.

The home environment device then determines if notification of the provisioning has been accepted (block 406). For example, a user may accept that provisioning by selecting a displayed control, pressing an identified keyboard key, entering required information, etc. In one alternative, the user may select ones of the user services which should be provisioned to the new device. If provisioning has not been accepted, the home environment device determines if provisioning has been released (block 408). For example, provisioning may be released when another home environment device provisions the new device. The other home environment device or the new device may broadcast a release notification indicating that provisioning should be released by the home environment device. If provisioning has not been release, control looks to block 406 to continue waiting for an acceptance or a release notification. If provisioning has been released, the program of FIG. 4 is terminated.

Returning to block 406, if the provisioning notification has been accepted, the home environment device sends provisioning data including a URL to the new device (block 410). The provisioning data including the URL may comprise one message or multiple messages (as shown in FIG. 2). Once the provisioning data including the URL has been transmitted the program of FIG. 4 is terminated.

While the example of FIG. 4 illustrates that provisioning data including a URL is transmitted, in some implementations, the provisioning data may not include a URL. In such examples, all provisioning data may be transmitted from the home environment device to the new device. For example, the home environment device may retrieve information about service accounts from the memory of the home environment device and/or from one or more of the provision datastore 114 or the provision datastore 116 and may transmit the information to the home environment device. Additionally or alternatively, the home environment device may conditionally transmit provisioning data and/or a URL to the new device. For example, the advertisement message of block 402 may include information about the capabilities of the new device. For example, the advertisement message may indicate that the new device (e.g. television 104) is capable of presenting streaming media and, optionally, may indicate that the new device is not capable of accessing a grocery store to obtain information or order groceries. Accordingly, the home environment device may transmit only information about services that the new device is capable of utilizing. For example, the services may be divided into categories and the home environment device may only transmit information about the categories supported by the new device. In implementations in which the home environment device transmits a URL for the new device to retrieve provisioning data, the home environment device may generate a URL that causes retrieval of information about services supported by the new device (e.g., the URL may include filter parameters specifying categories of information to be sent to the new device and/or filter parameters specifying categories of information not to be sent to the new device). Alternatively, the information about services may include only those services or categories that have been authorized by a user of the home environment device.

FIG. 5 is a table illustrating example provisioning data regarding services to which one or more users of the home environment 101 is subscribed or accesses. The example provisioning data includes a URL at which the service can be accessed, a username, a password, and a service category. The service category information may be used to customize which information is sent to which devices based on the capabilities of the devices. For example, in the example of FIG. 1, the mobile device 106 may transmit or cause to be transmitted the services in the grocery category to the refrigerator 102, the services in the media and the security category to the television 104, the voice categories to a telephony device, and all categories to a desktop computer. Of course, these allocations are only examples and the services may be distributed in any manner with or without regard to the capabilities and features of a device to be provisioned. Furthermore, the table of FIG. 5 is provided as an example and any other layout or configuration of the data may be utilized when implementing the methods and apparatus disclosed herein. The table of FIG. 5 may be stored at one or more of the refrigerator 102, the television 104, the mobile device 106 or any other device and/or may be stored for retrieval at one or more of the provision datastore A 114 or the provision datastore B 116.

FIG. 6 is a block diagram of an example computer 600 capable of executing the instructions of FIGS. 3 and 4 to implement the refrigerator 102, the television 104, the mobile device 106 of FIG. 1 and/or any other device. The computer 600 can be, for example, a server, a personal computer, a mobile phone (e.g., a cell phone), a personal digital assistant (PDA), an Internet appliance, a DVD player, a CD player, a digital video recorder, a BluRay player, a gaming counsel, a personal video recorder, a set top box, or any other type of computing device.

The processing system 600 of the instant example includes a processor 612. For example, the processor 612 can be implemented by one or more microprocessors or controllers from any desired family or manufacturer. Processing system 600 may be configured to perform various procedures described herein, including one or more of the example flow charts in FIGS. 3-4.

The processor 612 is in communication with a main memory including a volatile memory 614 and a non-volatile memory 616 via a bus 618. The volatile memory 614 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 616 may be implemented by flash memory and/or any other desired type of memory device. Access to the main memory 614, 616 is controlled by a memory controller.

The computer 600 may include an interface circuit 620. The interface circuit 620 may be implemented by any type of interface standard, such as an Ethernet interface, a universal serial bus (USB), and/or a PCI express interface.

One or more input devices 622 are connected to the interface circuit 620. The input device(s) 622 permit a user to enter data and commands into the processor 612. The input device(s) can be implemented by, for example, a keyboard, a mouse, a touchscreen, a track-pad, a trackball, isopoint and/or a voice recognition system. Other examples of the one or more output input 622 may be readily conceived by persons of skill in the relevant art.

One or more output devices 624 may be connected to the interface circuit 620. The output devices 624 can be implemented, for example, by display devices (e.g., a liquid crystal display, a cathode ray tube display (CRT), a printer and/or speakers). The interface circuit 620, thus, may include a graphics driver component. Other examples of the one or more output devices 624 may be readily conceived by persons of skill in the relevant art.

Together, the interface circuit 620, one or more input devices 622, and one or more output devices 624 may comprise a user interface of the computer 600.

The interface circuit 620 may include a communication device (e.g., communication device 56) such as a modem or network interface card to facilitate exchange of data with external computers via a network 626 (e.g., an Ethernet connection, a digital subscriber line (DSL), a telephone line, coaxial cable, a cellular telephone system, etc.).

The computer 600 may include one or more mass storage devices 628 for storing software and data. Examples of such mass storage devices 628 include floppy disk drives, hard drive disks, compact disk drives and digital versatile disk (DVD) drives.

The coded instructions of FIGS. 7 and 11 may be stored in the mass storage device 628, in the volatile memory 614, in the non-volatile memory 616, and/or on a removable storage medium such as a CD, DVD, BluRay, etc.

Although certain example methods, apparatus and articles of manufacture have been described herein, the scope of coverage of this patent is not limited thereto. On the contrary, this patent covers all methods, apparatus and articles of manufacture fairly falling within the scope of the claims of this patent.

What is claimed is:

1. A method performed by a particular home environment device, the method comprising:
receiving a request from a new device being added to a home environment network; and
transmitting provisioning information to the new device, the provisioning information including at least one of network access information and account information for accessing user services.

2. A method as defined in claim 1, wherein the request is received via a short range radio frequency connectivity.

3. A method as defined in claim 1, wherein the request is received via a network node of the home environment network.

4. A method as defined in claim 1, wherein the receiving and the transmitting are performed using a peer-to-peer connection that is different than the home environment network.

5. A method as defined in claim 1, wherein the request is broadcast to multiple devices already connected to the home environment network, the multiple devices including the particular home environment device.

6. A method as defined in claim 5, further comprising notifying the others of the multiple devices that the particular home environment device will transmit the provisioning information.

7. A method as defined in claim 5, wherein notifying others of the multiple devices causes the others of the multiple devices to terminate display of a notification of the request.

8. A method as defined in claim 1, further comprising displaying a notification of the request.

9. A method as defined in claim 1, wherein the account information includes at least one of a username and a password, or an API key.

10. A method as defined in claim 1, wherein the network access information includes an encryption key associated with the network.

11. A computer readable storage medium comprising instructions that, when executed, cause a machine to:
receive a request from a new device being added to a home environment network; and
transmit provisioning information to the new device, the provisioning information including at least one of network access information and account information for accessing user services.

12. A computer readable storage medium as defined in claim 11, wherein the request is received via a short range radio frequency connectivity.

13. A computer readable storage medium as defined in claim 11, wherein the request is received via a network node of the home environment network.

14. A computer readable storage medium as defined in claim 11, wherein the instructions, when executed, receive and the transmitting are performed using a peer-to-peer connection that is different than the home environment network.

15. A computer readable storage medium as defined in claim 11, wherein the request is broadcast to multiple devices already connected to the home environment network, the multiple devices including the particular home environment device.

16. A computer readable storage medium as defined in claim 15, wherein the instructions, when executed, cause the machine to notify the others of the multiple devices that the particular home environment device will transmit the provisioning information.

17. A computer readable storage medium as defined in claim 16, wherein notifying others of the multiple devices causes the others of the multiple devices to terminate display of a notification of the request.

18. A computer readable storage medium as defined in claim 11, wherein the instructions, when executed, cause the machine to display a notification of the request.

19. A computer readable storage medium as defined in claim 11, wherein the account information includes at least one of a username and a password, or an API key.

20. A computer readable storage medium as defined in claim 11, wherein the network access information includes an encryption key associated with the network.

21. A method performed by a new device being added to a home environment network, the method comprising:
transmitting a request to be added to the home environment network; and
receiving provisioning information from an existing home environment network device, the provisioning information including at least one of network access information and account information for accessing user services.

22. The method of claim 21, wherein said transmitting includes broadcasting an advertisement message to indicate the request to be added to the home environment network.

23. The method of claim 21, further comprising:
transmitting a release message to indicate that the new device has received provisioning information from the existing home environment network device.

24. The method of claim 21, further comprising:
accessing at least one user service using the account information.

25. The method of claim 21, wherein the provisioning information includes a provisioning URL, and the method further comprises:
downloading provisioning data based upon the provisioning URL.

26. The method of claim 21, wherein the request includes information about the capabilities of the new device.
